(19) United States
(12) Patent Application Publication
(10) Pub. No.: US 2004/0015437 A1
(43) Pub. Date: Jan. 22, 2004

(54) System for providing information using medium indicative of effective term and authorization of charged internet site and settling accounts for use of provided information

(76) Inventors: Je-Hyung Choi, Seoul (KR); Nam Hoon Cho, Inchun Kwangyuk-Si (KR); Nam il Choi, Seoul (KR)

Correspondence Address: Frank Chau, F Chau & Associates, Suite 501, 1900 Hempstead Turnpike, East Meadow, NY, 11554, US

(21) Appl. No.: 10/297,807

(22) PCT Filed: Jun. 9, 2001
(86) PCT No.: PCT/KR01/00988

(30) Foreign Application Priority Data
Jun. 10, 2000 (KR) 2000/32009

(51) Int. Cl. G06F 17/60

(52) U.S. Cl. 705/40; 705/44

(57) ABSTRACT

A user accesses the Internet, uses a chargeable service over the Internet and pays for use of the chargeable service. Accordingly, the present invention relates to a system providing information and billing for use of the information provided, using a medium storing therein an effective term and an authorization thereof at a pay site over the Internet, wherein use of the information can be billed and the billed amount is settled in an exact manner, without providing personal information of a client, as an information user. The billing system is characterized in that an authentication medium is bought in advance, and unique authentication information generated by entering hardware information specific to the user's computer is transmitted to a service gate and the user is allowed to log in the service gate, and payment for use of the information is transferred to a contents provider from the service gate.

### TECHNICAL FIELD

The present invention relates in general to a system for allowing a user to access the Internet, to use chargeable services over a pay Internet site and pay for use of the chargeable service, and more particularly, to a system for providing information, using a medium storing therein an effective term and license of use thereof, from a pay Internet site, and settling accounts charged for use of information provided therefrom, thereby providing information using the medium and settling any charge for use of the information provided at a pay Internet site constructed so as to adjust and settle payment for use of the information in an exact manner, without personal information entered by a client as an information user.

The system of this invention allows the user's identity to be exactly authenticated, thereby preventing any damages from disclosure of personal information and solving problems due to appropriation and/or losing of the user's ID and password, and allows provision and use of chargeable information to be available without need of entering a user's personal information generally required for gaining membership by a contents provider (CP) over the Internet and the user's banking information for settlement, thereby overcoming the user's reluctance to disclose his/her personal information when using information over the Internet, and promoting Internet-using businesses because many more users will be able to access the Internet in a convenient and secure manner.

### BACKGROUND ART

As well known to those skilled in the art, keeping pace with rapid development of computer systems, there has also been a great and powerful development in the field of personal computers. Such development has been useful in processing information.

Along with the development of personal computers, there has also been rapid progress in Internet-related technologies. Using these technologies, personal computers can be interconnected by a network to thereby allow information to be distributed between personal computers.

The Internet provides a variety of functions necessary and useful in our daily life, for example, information retrieval and electronic commerce, etc.

However, in order to perform information retrieval and/or electronic commerce by means of the Internet, a user has to access Internet sites providing such services (hereinafter referred to as simply “service gate”). Thus, it is necessary to certify the authenticity of the user in an exact manner.

Such authentication is important in pay service gates because it is involved in making money. Therefore, the authentication is really a significant issue in Internet businesses.

Recent surveys have reported that a large number of Internet users felt very negative about using Internet sites because of the risk that their personal information will be disclosed. Such negative feeling results from a danger that their privacy may be violated. For this reason, a large number of Internet users are reluctant to gain membership by entering their personal information into Internet sites other than those sites essentially useful for them.

Such reluctance by the users has adversely affected the business of a large number of pay Internet sites, which is a direct cause of those sites' loss of profits. Where users are requested to manipulate a lot of keys consecutively or to click too frequently a mouse in order to gain membership for logging into an Internet site, even though they are not requested to enter their personal information, many of them give up using the Internet site and try to access another site.

As described above, in order to enjoy any conveniences offered by the Internet, a user has to enter his/her personal information, and therefore, the user's concern over any possible disclosure of his/her personal information restricts persons from using the Internet in a positive manner.

Among many examples of using information over the Internet in a conventional system, a system comprised of a pay Internet site providing chargeable information, requesting a user to gain membership to that site and making payment for use of information will be observed.

Referring to FIG. 1 showing a conventional process of using chargeable information using the Internet and a conventional payment system settling charges for use of information, there is established a relationship of providing information and using the information between a contents provider (CP) 200 and a client 100.

If the client 100 accesses the Internet for the purpose of using information and links to a site operated by the CP 200, the CP requests the user to gain membership.

To use the information, it is obligatory for the user to gain membership, and the user has to enter his/her personal information in order to gain the membership.

Entrance of the personal information causes the user to feel an uneasiness because of the risk that his/her personal information may be disclosed, and the user is further caused an inconvenience in entering the personal information.

After the personal information is inputted, the CP approves registration of the user as a member. Thereafter, the user is allowed to log in and then to use information provided thereby.

If the user is linked to chargeable information, the CP asks the user how to pay for use of information and requests him/her to make the payment. The client has an option to select payment by credit card, cellular phone, or cash telegraphic transfer as appropriate, and if the payment means is selected, a process of settling the charge is performed.

In most cases, payment by credit card has been preferred. If information about the user's credit card is inputted, the CP 200 requests the card issuer to authenticate whether the credit card information provided by the client 200 and then to approve the payment. After the authentication is made, the CP provides the client with the information.

A client is billed for use of information and the card issuer is requested to pay the charge to the CP. The card issuer transfers by telegraphic wire the charged amount to a bank account opened by the CP.

As can be understood from the above, a conventional system is disadvantageous in that a user has to exactly enter his/her personal information and banking information, and it also gives the user trouble in entering the personal information and banking information in all the sites, which he/she visits.

A contents provider has also a burden to request a user to enter too much personal information for operating businesses of his/her pay information; and such excessive request has resulted in deteriorating profits from doing business on the Internet because of users' distance for using the Internet.

### DISCLOSURE OF THE INVENTION

Therefore, the present invention has been proposed to solve the problems described above, and accordingly it is an object of the present invention to provide a system for providing information and billing for use of information using an authentication medium recorded with an effective term and license of use of the medium at a pay Internet site, wherein an authentication information is generated by combining inherent hardware information of a user's computer and an authentication formula by means of the prepaid authentication medium and the generated authentication information is transmitted to a service gate, exclusive of the user's personal information, and the user is allowed to receive the authentication only at a specific computer designated by the user and to log in, thereby making it possible to use information in a safe and secure manner.

It is another object of the present invention to provide a system for providing information and billing for use of information using an authentication medium recorded with an effective term and license of use of the medium at a pay Internet site, wherein a client is not requested to enter his/her personal information, thereby contributing to increasing the profits of the contents provider's business.

It is also another object of the present invention to provide a system for providing information and billing for use of information using an authentication medium recorded with an effective term and license of use of the medium at a pay Internet site, wherein a related site preventing damages due to disclosure of the client's personal information and banking information and allowing free use of a pay information site is included in an authentication medium as a package, and thus, a contents provider announces and promotes his/her site in an easier manner.

It is still another object of the present invention to provide a system for providing information and billing for use of information using an authentication medium recorded with an effective term and license of use of the medium at a pay Internet site, wherein accounts for use of information are prepaid by purchasing an authentication medium for using information, use amount of information and charges for use thereof depending upon accessing a concerned site within the effective term of the authentication medium are converted and accumulated into points, and the accumulated points are transferred for the contents provider from the prepaid accounts, thereby allowing the contents provider to operate his/her site in a stable manner.

These and other objects may be accomplished by a provision of an authentication medium which a user acquires in pre-payment, the authentication medium generating a unique and differentiated authentication information by entering inherent hardware information of the user's computer into an operational expression for authentication, wherein some pieces of authentication formula are recorded in the authentication medium, and they are combined with the remaining pieces of the authentication formula received from a server of a service gate, thereby forming a complete authentication formula, into which the inherent hardware information is entered, to thereby provide a complete authentication information, after which the complete authentication information is transmitted to the server together with the serial number of the authentication medium, to thereby register the user as a member and grant an access to the user, and the charges for use of information are accumulated into points in case the authenticated user uses information from a pay site and the charged accounts are paid to the contents provider by the service gate having sold the authentication medium.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view showing a conventional billing system over the Internet;

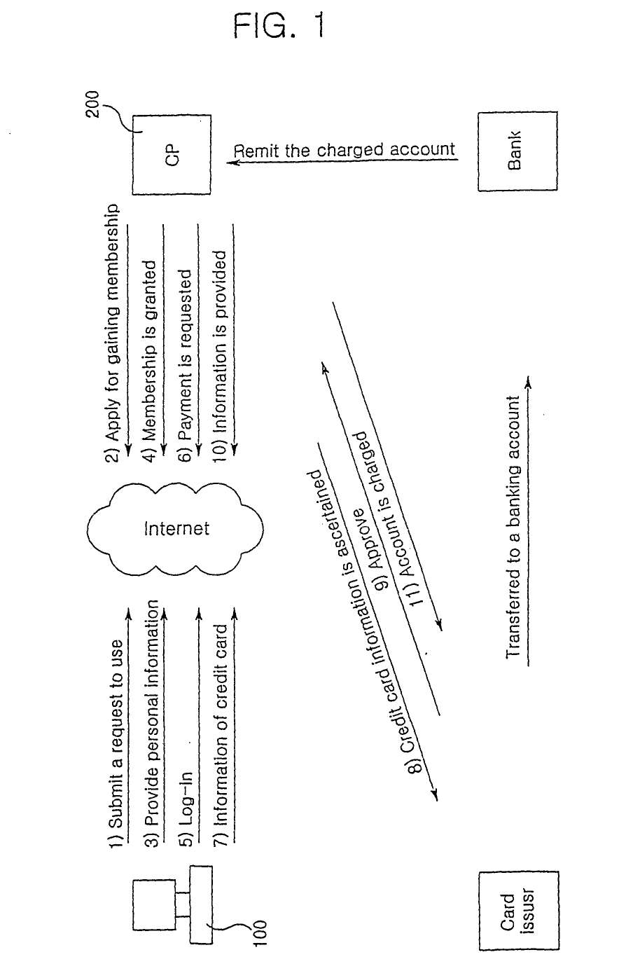

FIG. 2 is a schematic view showing a billing system using the Internet according to the present invention;

FIG. 3 is a block diagram showing a configuration of the billing system using the Internet according to the present invention;

FIG. 4 is a flowchart showing an embodiment of the present invention related to circulation of information; and

FIG. 5 is a flowchart showing an embodiment of the present invention related to use of information.

### BEST MODE FOR CARRYING OUT THE INVENTION

Herein below, the technical idea of the present invention will be described in more detail.

For the sake of convenience, some terms referred to in describing the present invention have the following definition.

Authentication formula: values transmitted from a server computer to a client computer, which are continuously changed at regular time intervals,

Piece of authentication formula: a portion of the authentication formula recorded inside of the authentication medium, which is combined with a formula transmitted from a server computer, forming a complete authentication formula,

Authentication medium: a recording medium such as a CD-ROM, recording programs therein, including inside of the medium combination keys to combine pieces of authentication formula necessary for authentication, and the authentication formula received from the server computer,

Serial number of authentication medium: a number sequence assigned when an authentication medium is produced, to prove that the authentication medium is regularly produced,

Service gate: a server responsible for actual authentication, connecting a server to a plurality of contents providers (CPs),

Authentication software: logic for performing an authentication procedure,

Authentication information: values obtained by operating the authentication formula, which are data values actually transmitted from a client server to a server computer, and

Hardware reference log: hardware list referred to when first installing authenticated software.

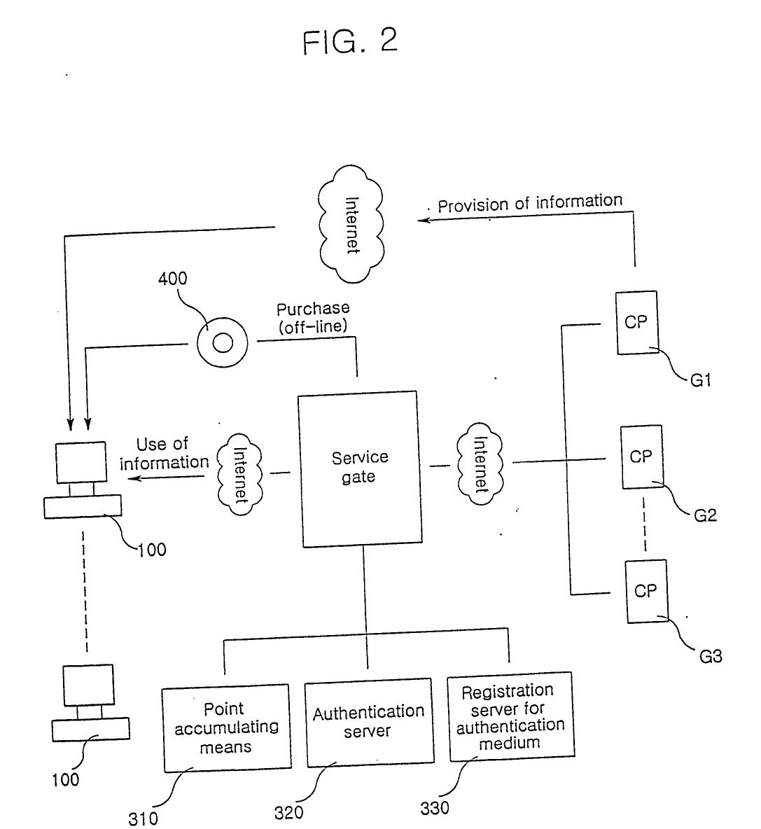

FIG. 2 is a schematic view showing a billing system over the Internet according to the present invention.

The billing system according to the present invention is comprised of a contents provider (CP) providing information of a pay Internet site, and a user making an access to the CP's Web page to use the information, wherein a user is requested to pay for use of information at a fixed rate or a fee-for-service rate, and only the user having made the payment is allowed to use the information. In the system, web sites are grouped according to types of information provided, and contents providers are also classified into a plurality of groups (G1˜Gn), and a service gate 300 is provided, for arranging authentication between a contents provider and a user, wherein the service gate grants the user in access thereto an authorization to use the information, through an authentication medium storing therein an effective term and a license (authorization) thereof, and only clients having obtained the authentication are allowed to use the information.

The service gate 300 is comprised of a point accumulating means 310 accumulating the amount charged for using information from a contents provider (CP) by converting the time during which the service gate detects access by a client into points, an authentication server authenticating the user's authenticity, and a registration server of an authentication medium allowing registration of the authentication medium at the time when the user first installs the medium, and recording and managing the effective term and the authorization of the medium.

The authentication medium with which a user is allowed to access a pay web site has been described in detail in a patent application titled “Certification Method Using Variable Encryption Key System Based On Encryption Key Of Certification Medium And Inherent Information Of Computer Hardware, And Certification Medium For Storing The Same And Indicating Effective Tern And Authorization Thereof” which was filed to KIPO by the inventor of this invention.

Briefly describing an authentication medium, a user (client) purchases an authentication medium on which authentication software is recorded or acquires the medium through any other methods, in order to access a contents provider through the Internet.

The authentication medium includes therein some pieces of an authentication formula as a part of the authentication formula.

The pieces of authentication formula are inserted into an execution file and then compiled. The authentication formula is comprised of a plurality of pieces of authentication formula.

On the authentication medium is indicated a serial number given at the time of production thereof by the manufacturer, the serial number being transmitted to a server at the time of authentication.

If a user's computer is accessed to the server after the authentication medium is installed thereto, the server transmits to the client the remaining pieces of the authentication formula. The transmitted pieces of authentication formula are combined with the pieces of authentication formula included in the user's computer, thereby forming a complete authentication formula.

Proper information concerning specific hardware within the client's computer, having an invariable and unique value, is read out and inputted into the complete authentication formula, thereby generating authentication information after operating them.

The authentication information is transmitted to a server together with the serial number of the authentication medium and the server decides whether the user's identity is authenticated after reading out the authentication information.

The proper information concerning specific hardware within the client's computer refers to information having a unique value which is different from any other computers. Such information is unique, thereby maintaining a user's information in a secure manner.

The proper information is comprised of MAC address of a network card, serial numbers of a hard disk and a RAM, or a serial number of a central processing unit (CPU).

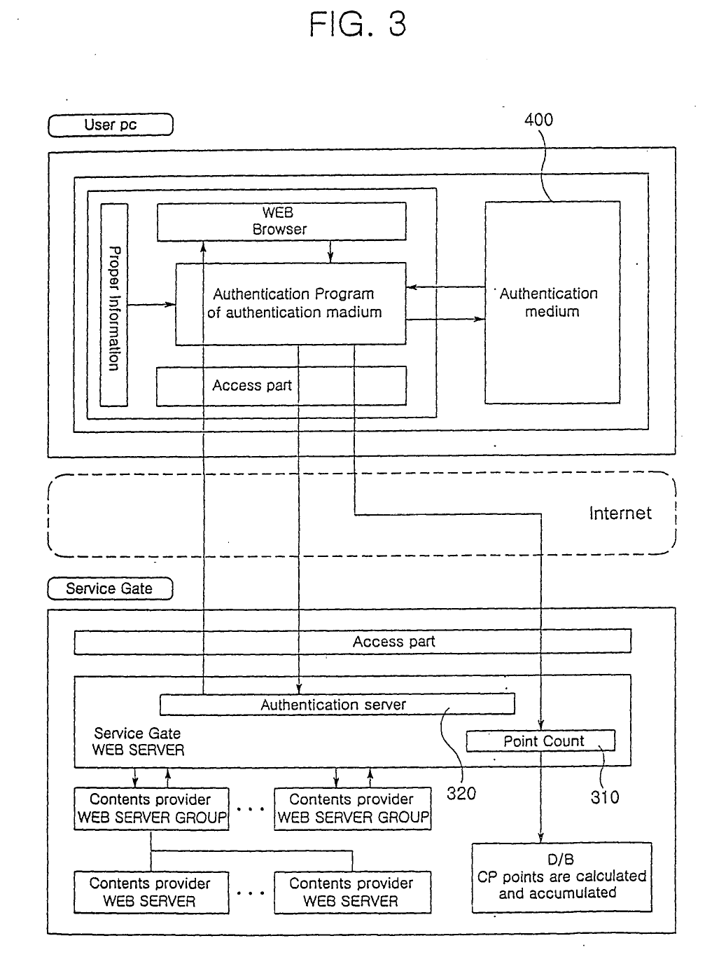

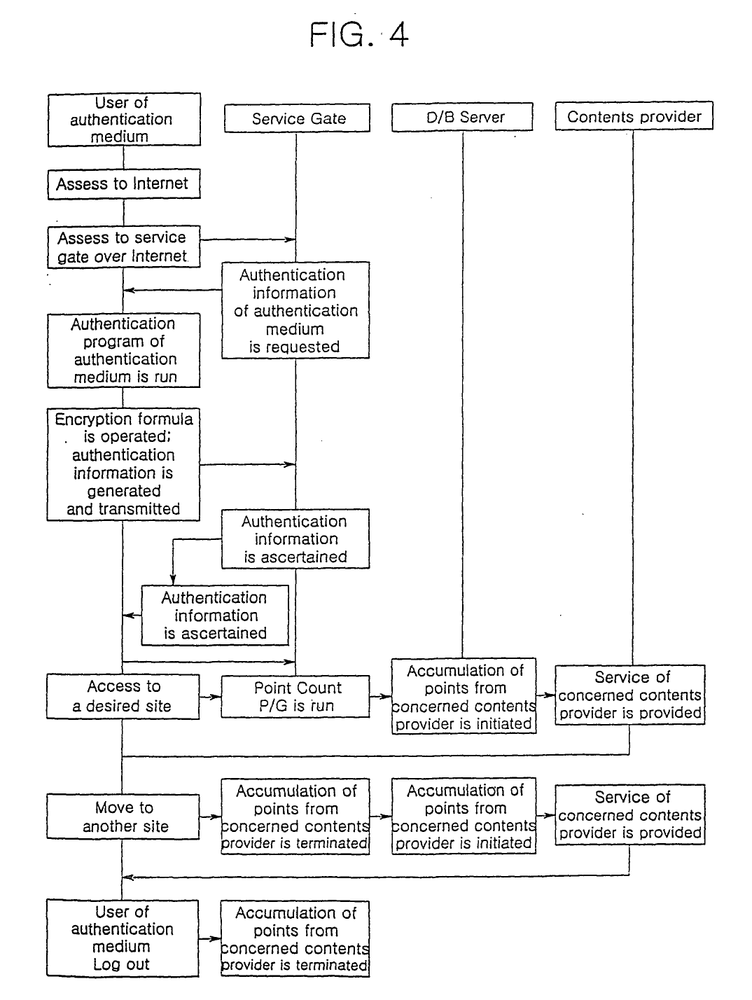

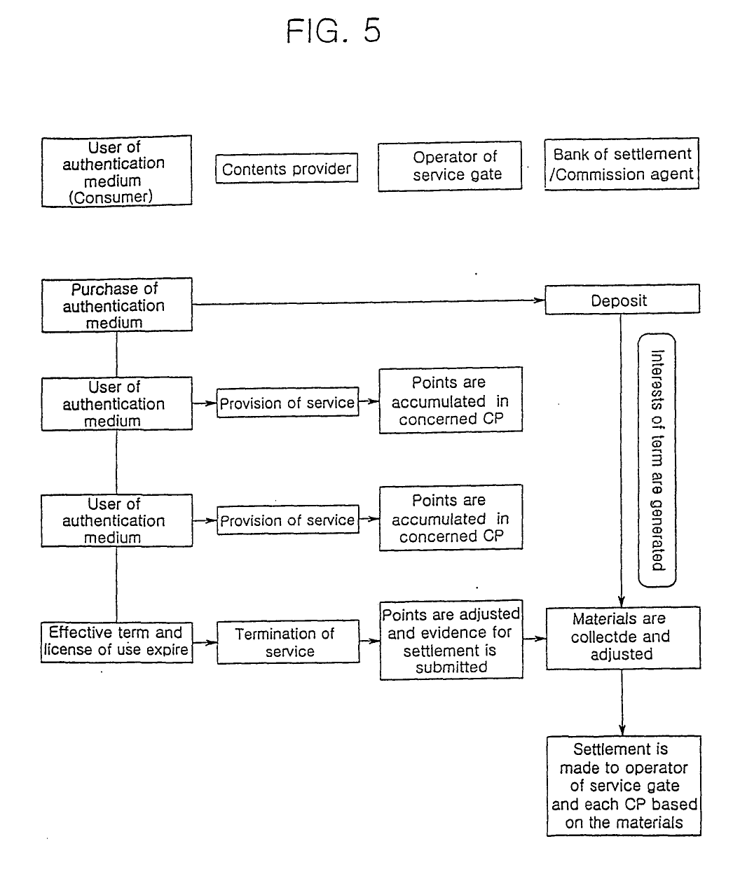

FIG. 3 is a block diagram showing a configuration of the billing system using the Internet according to the present invention, FIG. 4 is a flowchart showing an embodiment of the present invention related to circulation of information, and FIG. 5 is a flowchart showing an embodiment of the present invention related to use of information.

The authentication medium 400 may be manufactured for the following purposes: education, entertainment, information retrieval, adults only, and the produced authentication media are classified into groups (G1˜Gn) according to uniform resource locators (URLs) of the contents providers depending upon their respective purposes, so as to make it easy to link thereto.

Once a user purchases an authentication medium 400, this means that the payment for use of information has been made to the concerned service gate in advance.

Authentication software recorded with the authentication medium 400 is installed to a user's computer by means of the authentication medium 400 after the user buys the authentication medium 400. After the installation is finished, the user's computer makes an access to a web browser exclusively for the concerned service gate by means of the authentication medium.

If the client accesses the service gate, the service gate requests authentication information of the authentication medium which the client currently possesses.

If the authentication program installed to the client's computer is run, the pieces of authentication formula transmitted from the server and the remaining pieces of authentication formula recorded with the authentication formula are combined with each other, to thereby generate a complete authentication formula, and the generated authentication information is transmitted to the service gate.

If the authentication information transmitted from the client is received, an authentication server 320 of the service gate ascertains the authentication information of the authentication medium and then registers it with the registration server 330, checks the effective term and authorization of the authentication medium, and transmits to the user an initial display of the concerned group providing the information requested by the user.

The user selects a site operated by the contents provider he/she wants to access among available information providing groups, and accesses the site.

The access is performed through a web browser constructed by the service gate. If the user logs into a specific contents provider, the contents provider requests the service gate to authenticate the identity of the logging-in client. While the authentication is being carried out, charges for using the information are calculated. The charges for use of information are summed up until use of the concerned information is finished. The charge for use of information is accumulated by a CP point accumulating means 310 of the service gate, and the result is recorded in a database for maintaining the concerned points.

After the authentication is performed, the CP initiates to provide information, and the provided data is transmitted to the client, without passing through the service gate.

If the user changes a URL in order to move to another CP from the CP currently in access, the service gate finishes accumulation of points of the accessed CP and initiates accumulation of points of the new CP in access. When the URL is changed, the service gate repeats the processes of authenticating the user's identity and the CP then initiates services of providing information.

When a user of an authentication medium logs out of the service gate, the points of the CP immediately before logging-out are accumulated and then the site is inactivated.

A process of billing and settling the charge for use of information incurred in the information providing method described above will be described in more detail, with reference to FIG. 5.

When a user of an authentication medium pays for the authentication medium when purchasing it, the payment is deposited into a bank account of the CP or delivered to the service gate through a commission agent thereof.

By purchasing the authentication medium, the user has a license of use legally granted thereto, and is provided with the Internet services using the authentication medium according to the method described above.

The effective term of the authentication medium and sites accessible to the medium are defined by the service gate, and free use of services is allowed within the predetermined limit.

An operator of the service gate accumulates points in accordance with service-using time and contents used by the user of the authentication medium. On the basis of the database storing the accumulated points, if the term and authorization of the authentication medium expire, the provision of services is terminated, and the charge made by the contents provider is settled from the account having received payment for selling the authentication medium.

The processes and billing method described above are not limited to pay Internet sites, but may also be used in authenticating a user's identity in an exact manner, as in Internet banking transactions.

For example, if a user who wishes to use the Internet banking service visits a real bank providing the concerned Internet banking service in order to apply for use of the Internet banking service, the bank gives the user an authentication medium for allowing the user to pass through a service gate by which the Internet banking user is allowed to access the bank network at the same time when an authorization to access the bank is granted to the user. By means of the authorization medium, authentication information unique only to the user is generated, from which it can be expected that authorization will be conducted whenever the user uses the Internet banking service.

As described above, whenever an authentication is requested, the server at the service gate transmits to a client some pieces of a new authentication formula and the client enters hardware-specification information in his/her sole possession into the authentication formula, thereby generating a complete authentication formula by operating the pieces of the authentication formula, to thereby make it possible to generate authentication information in a variable manner. In terms of the password used for authentication, various encryption systems known are applied as they are, and therefore, even if the data in the course of transmission is scanned, the whole contents of the authentication formula are not disclosed, thereby protecting the user's personal information in a secure and safe manner.

Industrial Applicability

As apparent from the above description, the present invention employs a system requesting each of contents providers to allow use of services provided therefrom, using a prepaid authentication medium with which a user's identity is authenticated passing through a concerned service gate, without request that the user should enter any personal information or banking information about himself/herself, thereby causing the user no concern about the disclosure of his/her personal information, and promoting use of information over the Internet; in addition, since the charges for use of information are accumulated as points and they are settled at the service gate, no efforts to authenticate the user's identity are necessary in terms of the contents provider and easy and convenient access to the service gate is allowed in terms of the user, thereby contributing to increasing the profits of the contents provider's business.

The present invention has also an effect of preventing damages due to loss or appropriation of a number of credit card, user's ID and password, etc. which has occurred in the conventional authentication method. In addition, since authentication information is generated by combining pieces of authentication formula transmitted from a server in real time and the remaining pieces of authentication formula recorded in the user's computer, and an authentication on the basis of the generated authentication information is requested to the server, it is possible to protect user's personal information such as credit card number, user's ID and password from appropriation and loss thereof in a secure and safe manner.

According to the present invention, a user's password is not selected at the user's discretion, but information having a unique value among specific hardware information to the user's computer, to be inserted in the generated authentication formula, is used as a password, and thus, an authorization to authenticate the user's identity is granted only to one computer, having an excellent security effect.

Also, the present invention does not use information stored in the user computer as specific hardware information, but uses information about an object designating the most appropriate hardware according to the priority among hardware lists which can be referred to for that purpose, and thus, whenever the authentication is requested, concerned hardware information is accessed to generate a value for authentication password, making it impossible to reproduce the password.

In addition, an authentication formula is completed by combination of pieces of the authentication formula compiled in an authentication formula and the remaining pieces thereof transmitted from the server, and thus, even if the data is scanned in the course of transmission, the whole contents are not disclosed, thereby assuring the security thereof.

As described above, the present invention does not request a user's personal information, which has conventionally been provided for authentication for access to the Internet and payment for use of information over the Internet, but simply requests the user to purchase an authentication medium on a legal basis through an authorized channel, the authentication medium being used for authentication, making it unnecessary for the user to enter his/her ID, password, a serial number of the authentication medium, etc. and removing inconveniences from such entrance.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A system providing information and billing for use of the information at a pay Internet site by using an authentication medium showing an effective term and authorization thereof, and charging for use of information by a user at a fixed rate or a fee-for-service rate, and allowing only a user having paid the charge to use the information, between a contents provider (CP) of a pay site providing information over the Internet and a user making an access to the CP's Web page to use the information provided, wherein
contents providers grouping their sites according to the type of information provided are classified into a plurality of groups (G1˜Gn);
a service gate is provided, said service gate arranging an authentication between each of the contents providers at each group and users; and
the authentication is granted using information generated when a user accesses a service gate through the authentication medium showing an effective term and a license of use granted to the medium and the user having obtained the authorization is allowed to use information from the service gate.

2. The system as set forth in claim 1, wherein said service gate comprises:
point accumulating means for accumulating the time during which the service gate detects the logging-in by the user into points, to bill for use of information;
an authentication server granting an authentication to the user; and
a registration server granting registration of the purchased authentication medium which is first installed to the user' computer, recording and maintaining an effective term and authorization of the authentication medium.

3. The system as set forth in claim 1, wherein said authentication server of the service gate requests the user to provide authentication information at least one time when the user first gains membership, when accessing the service gate, and when an URL in access by the user is changed.

4. The system as set forth in claim 2, wherein said service gate converts the points accumulated in the point accumulating means into accounts to be charged for use of information and then settles the charged accounts for the contents provider.

5. The system as set forth in claim 1, wherein said authentication medium is a CD-ROM including authentication software and some pieces of the authentication formula, and defined by an effective term and authorization thereof.
